(19) United States
(12) Patent Application Publication
(10) Pub. No.: US 2026/0246512 A1
(43) Pub. Date: Aug. 20, 2026

(54) CAPABILITY REPORTING METHOD AND APPARATUS, STORAGE MEDIUM, TERMINAL DEVICE, AND NETWORK DEVICE

(71) Applicant: Beijing Xiaomi Mobile Software Co., Ltd., Beijing (CN)

(72) Inventor: Juan ZHANG, Beijing (CN)

(73) Assignee: Beijing Xiaomi Mobile Software Co., Ltd., Beijing (CN)

(21) Appl. No.: 19/164,531

(22) PCT Filed: Mar. 16, 2023
(86) PCT No.: PCT/CN2023/082018

§ 371 Date: Sep. 11, 2025

(51) Int. Cl. H04B 7/06; H04L 43/065

(52) U.S. Cl. CPC H04B 7/0617; H04L 43/065

(57) ABSTRACT

A capability reporting method and apparatus, a storage medium, a terminal device, and a network device. The method includes: reporting first capability information to a network device, wherein the first capability information can be used for indicating whether a terminal device in a first frequency range supports a beamforming capability.

### CROSS-REFERENCE TO RELATED APPLICATION

The present application is a National Stage of International Application No. PCT/CN2023/082018, filed on Mar. 16, 2023, the entire disclosure of which is incorporated herein by reference for all purposes.

### TECHNICAL FIELD

The present disclosure relates to the field of communication technology, and more particularly to a capability reporting method and apparatus, a storage medium, a terminal device, and a network device.

### BACKGROUND

Beamforming is a multi-antenna transmission technology, and its main principle is to utilize the wave interference principle to generate a highly directional radiation pattern, enabling the main lobe of the radiation pattern to adaptively point toward the direction of the mobile terminal. In a communication system, beamforming can concentrate transmission energy in a specific direction by increasing the transmission power in that direction while reducing the transmission power in other directions. This achieves the goals of extending the communication distance in the desired direction and avoiding interference in other directions.

### SUMMARY

The present disclosure provides a capability reporting method and apparatus, a storage medium, a terminal device, and a network device.

According to a first aspect of an embodiment of the present disclosure, a capability reporting method is provided, which is performed by a terminal device, and includes: reporting first capability information to a network device, wherein the first capability information indicates whether the terminal device in a first frequency range supports beamforming capability.

According to a second aspect of an embodiment of the present disclosure, a capability reporting method is provided, which is performed by a network device, and includes: receiving first capability information sent by a terminal device, wherein the first capability information indicates whether the terminal device in a first frequency range supports beamforming capability.

According to a third aspect of an embodiment of the present disclosure, a capability reporting apparatus is provided, and includes: a reporting module, configured to report first capability information to a network device. Wherein the first capability information indicates whether a terminal device in a first frequency range supports beamforming capability.

According to a fourth aspect of an embodiment of the present disclosure, a capability reporting apparatus is provided, and includes: a receiving module, configured to receive first capability information sent by a terminal device. Wherein the first capability information indicates whether the terminal device in a first frequency range supports beamforming capability.

According to a fifth aspect of an embodiment of the present disclosure, a terminal device is provided, and includes: a first processor and a first memory for storing instructions executable by the processor. The first processor is configured to execute the executable instructions to implement the capability reporting method provided in the first aspect of the present disclosure.

According to a sixth aspect of an embodiment of the present disclosure, a network device is provided and includes: a second processor and a second memory for storing instructions executable by the processor. The second processor is configured to execute the executable instructions to implement the capability reporting method provided in the second aspect of the present disclosure.

According to a seventh aspect of an embodiment of the present disclosure, a non-transitory computer-readable storage medium is provided, having computer program instructions stored thereon, the program instructions implement steps of the capability reporting method provided in the first or second aspect of the present disclosure when executed by a processor.

It should be understood that the above general description and the following detailed description are merely exemplary and illustrative and do not limit the present disclosure.

### BRIEF DESCRIPTION OF THE DRAWINGS

The foregoing and/or additional aspects and advantages of the present disclosure become apparent and readily understood from the following description of the embodiments in conjunction with the accompanying drawings.

FIG. 1 illustrates an application scenario applicable to a capability reporting method according to some embodiments.

FIG. 2 illustrates a flowchart of a capability reporting method according to some embodiments.

FIG. 3 illustrates a flowchart of a capability reporting method according to other embodiments.

FIG. 4 illustrates a flowchart of a capability reporting method according to other embodiments.

FIG. 5 illustrates a flowchart of a capability reporting method according to another embodiment.

FIG. 6 illustrates an example diagram of antenna pairs in a capability reporting method according to another embodiment.

FIG. 7 illustrates a flowchart of a capability reporting method according to other embodiments.

FIG. 8 illustrates a flowchart of a capability reporting method according to other embodiments.

FIG. 9 illustrates a flowchart of a capability reporting method according to other embodiments.

FIG. 10 illustrates a flowchart of a capability reporting method according to some embodiments.

FIG. 11 illustrates a block diagram of a capability reporting apparatus according to some embodiments.

FIG. 12 illustrates a block diagram of a capability reporting apparatus according to some embodiments.

FIG. 13 is a block diagram of a terminal device according to some embodiments.

FIG. 14 is a block diagram of a network device according to some embodiments.

### DETAILED DESCRIPTION

The example embodiments are described in detail here, and examples thereof are shown in the drawings. When the following description refers to the drawings, unless otherwise indicated, the same numbers in different drawings represent the same or similar elements. The implementations described in the following example embodiments do not represent all implementations consistent with the embodiments of the present disclosure. Instead, they are merely examples of apparatuses and methods consistent with some aspects of the present disclosure as detailed in the appended claims.

To facilitate understanding of the embodiments of the present application, some terminology used in the embodiments of the present application is explained below to facilitate understanding by those skilled in the art.

### 1) Terminal Device

A terminal device includes a device that provides voice and/or data connectivity to a user. Specifically, it includes a device that provides voice to a user, a device that provides data connectivity to a user, or a device that provides both voice and data connectivity to a user. For example, it may include a handheld device with a wireless connectivity function, or a processing device connected to a wireless modem. As an example, a terminal device may include a wireless terminal device, a mobile terminal device, or a user device. In the embodiments of the present disclosure, a terminal device may also be referred to as a terminal.

### 2) Network Device

The network device is also known as a radio access network device. The network device is a device that connects the terminal device to a wireless network. It may include an access network device, a core network device, and it may also include a device of a service provider, such as a server. For example, the network device includes, but is not limited to, a transmission reception point (TRP), a base station (such as gNB), a radio network controller (RNC), a Node B (NB), a base station controller (BSC), a base transceiver station (BTS), a home evolved NodeB (HeNB) or a home NodeB (HNB), a baseband unit (BBU), or the like.

### 3) Array Antennas

An antenna array is formed by a plurality of antennas arranged in a certain geometric structure, including one-dimensional linear array antennas and two-dimensional rectangular array antennas. Each antenna is also referred to as an array element. For example, a plurality of antennas may be arranged at a predetermined spacing to form an antenna array. In other words, an array antenna is a special type of antenna consisting of at least two antenna units arranged regularly or randomly, which achieves predetermined radiation characteristics through appropriate excitation.

### 4) Beamforming

By adjusting the phase/amplitude of the signal fed to each array element of the array antenna, in other words, by weighting the signal of each array element, the signal energy is focused in a specific direction, forming a directional beam. Beamforming can include digital beamforming, analog beamforming, and hybrid beamforming.

In the New Radio (NR) system, there are two main spectrum ranges: the first frequency range (Frequency Range 1, FR1) and the second frequency range (Frequency Range 2, FR2). The frequency range of the FR1 band is 450 MHz-6 GHz, which is also called the traditional cellular band (sub 6G), is a low-frequency band, and is also the core band of Fifth Generation (5G). The frequency range of the FR2 band is 24.25 GHz-52.6 GHz, that is, the high-frequency millimeter wave (mmWave) band. Due to the poor penetration ability of millimeter waves, the spatial fading is severe. In order to compensate for this shortcoming, the terminal device of millimeter wave can use the array antenna, and use a beamforming capability of the array antenna to form the antenna gain to enhance the transceiver capability of the terminal device.

The terminal device in the FR1 primarily uses omnidirectional antennas, with a plurality of built-in antennas for uplink and downlink multiple input multiple output (MIMO) or transmit-receive diversity. In addition, the terminal device in the FR1 can selectively support different transmit/receive combinations, including one transmit two receive (1T2R), one transmit four receive (1T4R), one transmit six receive (1T6R), one transmit eight receive (1T8R), two transmit two receive (2T2R), two transmit four receive (2T4R), two transmit six receive (2T6R), two transmit eight receive (2T8R), four transmit four receive (4T4R), four transmit six receive (4T6R), and four transmit eight receive (4T8R).

As previously mentioned, the terminal device in the FR1 primarily uses omnidirectional antennas to support different transmit/receive combinations. In this process, the terminal device can use the SRS (Sounding Reference Signal) TxSwitch (transmit antenna switching) capability to report the supported transceiver capability and corresponding fallback capability.

For example, if a terminal device supports two transmit four receive (2T4R), the hardware of the terminal device may correspondingly include two transmit links and two transmit antennas, as well as four receive links and four receive antennas. Therefore, the terminal device cannot utilize the beamforming capability to improve cell-edge coverage and enhancement.

To address the aforementioned issues, embodiments of the present application provide a capability reporting method and apparatus, a storage medium, a terminal device, and a network device to improve the reliability of emergency service transmission.

The following describes the application environment of the capability reporting method provided in this embodiment. As shown in FIG. 1, the application scenario includes terminal devices 11 and a network device 13. The terminal device 11 may be a terminal (UE) or other terminal-side devices, such as a mobile phone, a tablet personal computer, a laptop computer, a personal digital assistant (PDA), a mobile internet device (MID), a wearable device, a smart car, a vehicle-mounted device, or a robot. It is worth noting that the specific type of the terminal is not limited by this disclosure.

The network device 13 can be used to provide a communication network and allocate dynamic uplink and downlink resources to the terminal device. The network device 13 can be a base station. The base station is an apparatus deployed in an access network to provide wireless communication functions for terminals. The base station can be the base station of the serving cell of the terminal or the base station of a cell adjacent to the serving cell of the terminal. The base station can include various forms of macro base stations, micro base stations, relay stations, access points, and transmission reception points (TRPs), or the like. In systems using different wireless access technologies, the names of devices with base station functions may vary. In 5G New Radio (NR) systems, they are called gNodeBs or gNBs. As communication technology evolves, descriptions of the term “base station” may change.

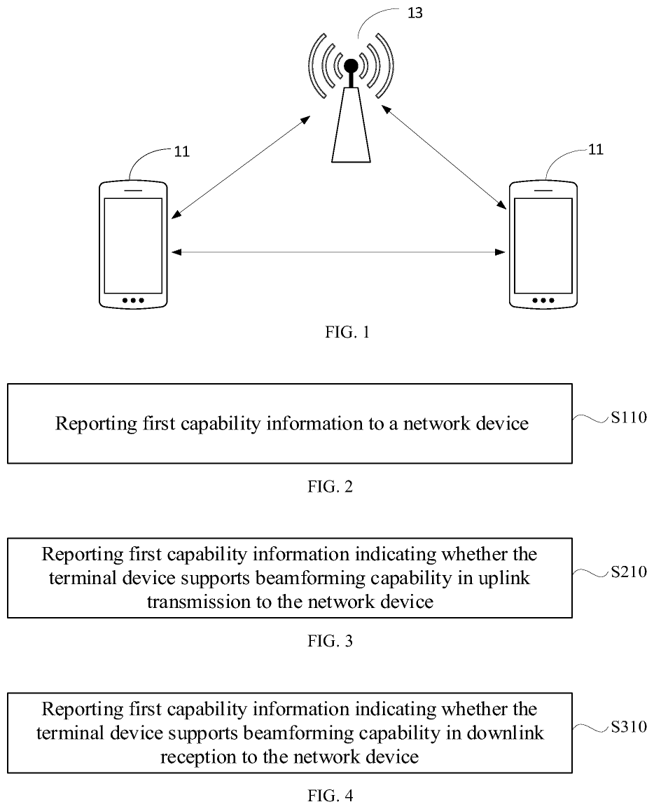

FIG. 2 is a flowchart illustrating a capability reporting method according to some embodiments. As shown in FIG. 2, the capability reporting method can be used in a terminal device and includes the following steps.

In step S110, the first capability information is reported to the network device.

In some embodiments, the terminal device can report the first capability information to the network device. The first capability information can be used to indicate whether the terminal device in the first frequency range FR1 supports the beamforming capability.

As a specific implementation, a terminal device may report first capability information to a network device per band, to indicate that the terminal device supports beamforming on which frequency band. That is, reporting of the first capability information is applicable to the single-carrier system. For example, the terminal device may inform the network device that it supports beamforming on frequency bands A and B through the first capability information.

As another specific implementation, the terminal device may also report the first capability information to the network device per band combination. That is, reporting of the first capability information is also applicable to the multi-carrier system. The multi-carrier system may involve technologies such as carrier aggregation and dual connectivity (DC), or the like.

As an example, the first capability information may include two fields. The first field indicates that the terminal device supports the beamforming capability, and the second field indicates that the terminal device does not support the beamforming capability. The terminal device may inform the network device whether it supports the beamforming capability through the values of the first and second fields.

As another example, when a value of the first capability information is 1, it indicates that the terminal device supports the beamforming capability. When a value of the first capability information is 0, it indicates that the terminal device does not support the beamforming capability.

In some embodiments, if the terminal device does not send the first capability information to the network device, it indicates that the terminal device does not support the beamforming capability. In other words, when the network device does not receive the first capability information sent by the terminal device, it determines that the terminal device does not support the beamforming capability.

It is known from above that the beamforming capability is a technique that weights the signal of each array element to focus the signal energy in a specific direction, thereby steering electromagnetic wave transmission and increasing propagation in a specific direction.

The embodiments of the present application provide that a terminal device may send first capability information to a network device. The first capability information may be used to indicate whether the terminal device in the first frequency range FR1 supports the beamforming capability. This enables the terminal device in the FR1 to utilize beamforming to improve cell coverage, i.e., beamforming may enhance the transceiver capability of the terminal device in the FR1.

FIG. 3 is a flowchart illustrating a capability reporting method according to other embodiments. As shown in FIG. 3, the capability reporting method may be used in a terminal device and includes the following steps.

In step S210, first capability information indicating whether the terminal device supports the beamforming capability in an uplink transmission is reported to the network device.

In some embodiments, a terminal device may send first capability information to a network device, and the first capability information may be used to indicate whether the terminal device supports the beamforming capability in the uplink transmission.

For example, the first capability information may include two fields. The first field indicates that the terminal device supports the beamforming capability in the uplink transmission, and the second field indicates that the terminal device does not support the beamforming capability in the uplink transmission. The terminal device may inform the network device whether it supports the beamforming capability in an uplink transmission through values of the first and second fields.

As another example, when a value of the first capability information is 1, it indicates that the terminal device supports the beamforming capability in the uplink transmission, and when a value of the first capability information is 0, it indicates that the terminal device does not support the beamforming capability in the uplink transmission.

In some embodiments, if the terminal device does not send the first capability information indicating whether the terminal device supports the beamforming capability in the uplink transmission to the network device, it indicates that the terminal device does not support the beamforming capability in the uplink transmission. In other words, when the network device does not receive the first capability information sent by the terminal device indicating whether the terminal device supports the beamforming capability in the uplink transmission, it determines that the terminal device does not support the beamforming capability in the uplink transmission.

It should be noted that, for a plurality of embodiments or features separated by “or,” even if some features are not implementable, this does not affect other solutions. Furthermore, where no conflict exists, the embodiments of the present disclosure can be combined with other embodiments or implementations of capability reporting methods and their various optional solutions, which are not detailed here.

The embodiments of the present application provide that a terminal device can report first capability information to a network device. This first capability information can be used to indicate whether the terminal device supports the beamforming capability in the uplink transmission, thereby enhancing the transmission capability in the Frequency Range 1.

FIG. 4 illustrates a flowchart of a capability reporting method according to still other embodiments. As shown in FIG. 4, the capability reporting method can be used in a terminal device and includes the following steps.

In step S310, the first capability information, indicating whether the terminal device supports the beamforming capability in a downlink reception, is reported to the network device.

In some embodiments, a terminal device may send first capability information to a network device, and the first capability information may be used to indicate whether the terminal device supports the beamforming capability in the downlink reception.

For example, the first capability information may include two fields. The first field indicates that the terminal device supports the beamforming capability in the downlink reception, and the second field indicates that the terminal device does not support the beamforming capability in the downlink reception. The terminal device may inform the network device whether it supports the beamforming capability in the downlink reception through values of the first and second fields.

As another example, when a value of the first capability information is 1, it indicates that the terminal device supports the beamforming capability in the downlink reception, and when a value of the first capability information is 0, it indicates that the terminal device does not support the beamforming capability in the downlink reception.

In some embodiments, if the terminal device does not send the first capability information indicating whether the terminal device supports the beamforming capability in the downlink reception to the network device, it indicates that the terminal device does not support the beamforming capability in the downlink reception. In other words, when the network device does not receive the first capability information sent by the terminal device indicating whether the terminal device supports the beamforming capability in the downlink reception, it determines that the terminal device does not support the beamforming capability in the downlink reception.

It should be noted that, for a plurality of embodiments or features separated by “or,” even if some features are not implementable, this does not affect other solutions. Furthermore, where no conflict exists, the embodiments of the present disclosure can be combined with other embodiments or implementations of capability reporting methods and their various optional solutions, which are not detailed here.

The embodiments of the present application provide that a terminal device can report first capability information to a network device. This first capability information can be used to indicate whether the terminal device supports the beamforming capability in the downlink reception, thereby enhancing the transmission capability in Frequency Range 1.

In other embodiments, the terminal device can report to the network device the first capability information, indicating whether the terminal device supports beamforming capability in the uplink transmission and the downlink reception. Specifically, the terminal device can send the first capability information to the network device, and the first capability information can be used to indicate whether the terminal device supports the beamforming capability in the uplink transmission and the downlink reception.

As an example, the first capability information may include two fields. The first field indicates that the terminal device supports the beamforming capability in the uplink transmission and the downlink reception, and the second field indicates that the terminal device does not support the beamforming capability in the uplink transmission and the downlink reception. The terminal device may inform the network device whether it supports the beamforming capability in the uplink transmission and the downlink reception through values of the first and second fields.

As another example, the terminal device may also inform the network device that it supports the beamforming capability in the uplink transmission but does not support the beamforming capability in the downlink reception through the first capability information. Alternatively, the terminal device may also inform the network device that it supports the beamforming capability in the downlink reception but does not support the beamforming capability in the uplink transmission through the first capability information.

As another example, when a value of the first capability information is 1, it indicates that the terminal device supports the beamforming capability in the uplink transmission and the downlink reception, and when a value of the first capability information is 0, it indicates that the terminal device does not support the beamforming capability in the uplink transmission and the downlink reception.

In some implementations, if the terminal device does not send the first capability information to the network device, it indicates that the terminal device does not support the beamforming capability in the uplink transmission and the downlink reception. In other words, when the network device does not receive the first capability information sent by the terminal device indicating whether the terminal device supports the beamforming capability in the uplink transmission and the downlink reception, it determines that the terminal device does not support the beamforming capability in the uplink transmission and the downlink reception.

It should be noted that, for a plurality of embodiments or features separated by “or,” even if some features are not implementable, this does not affect other solutions. Furthermore, where no conflict exists, the embodiments of the present disclosure can be combined with other embodiments or implementations of capability reporting methods and their various optional solutions, which are not detailed here.

The embodiments of the present application provide that a terminal device can report first capability information to a network device. This first capability information can be used to indicate whether the terminal device supports the beamforming capability in the downlink reception, thereby enhancing the transmission capability in Frequency Range 1.

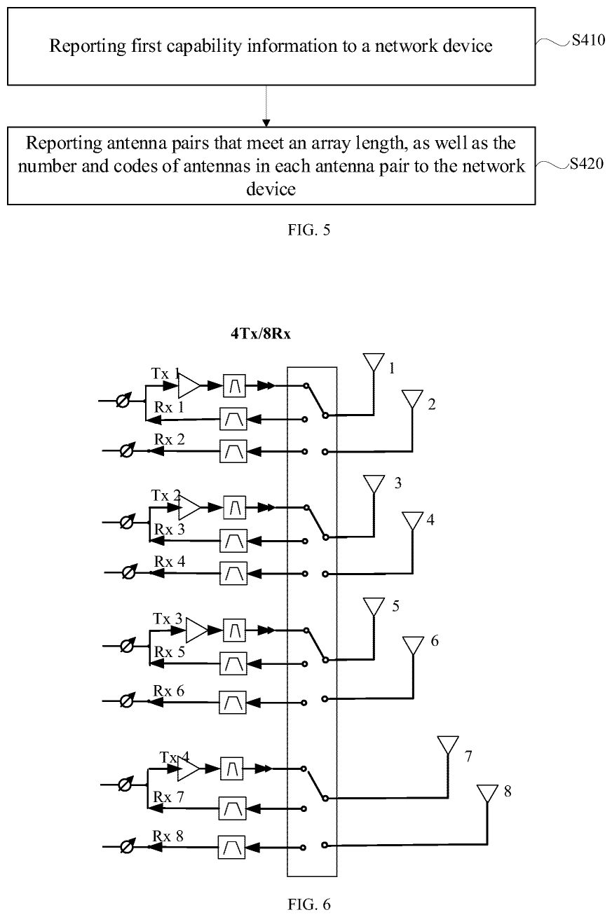

FIG. 5 illustrates a flowchart of a capability reporting method according to yet still other embodiments. As shown in FIG. 5, the capability reporting method may be used in a terminal device and includes the following steps.

In step S410, the first capability information is reported to the network device.

The specific implementation of step S410 has been described in detail in the previous embodiments and is not repeated here.

In step S420, antenna pairs that meet an array length, as well as the number and codes of antennas in each antenna pair, are reported to the network device.

In some embodiments, the terminal device may report to the network device antenna pairs that meet an array length, and the number and codes of antennas in each antenna pair. The array length may be the number and spacing of antennas on the terminal device. Alternatively, an antenna pair may be a group of antennas composed of two or more antennas, and the antennas can be used to implement the beamforming capability.

As an optional method, the terminal device can send to the network device the antenna pairs that meet an array length and the number and codes of antennas in each antenna pair, along with the first capability information.

Optionally, the terminal device can also send the antenna pairs that meet an array length, and the number and codes of antennas in each antenna pair, to the network device, after sending the first capability information. Optionally, the terminal device can also first send the antenna pairs that meet an array length, and the number and codes of antennas in each antenna pair, to the network device, and then report the first capability information to the network device. The specific timing for sending antenna pairs that meet an array length, as well as the number and codes of antennas in each antenna pair to the network device, is not specifically limited and can be determined based on actual circumstances.

In the embodiment of the present disclosure, the terminal device can report one or more antenna pairs that meet the array length to the network device. For example, there are two antenna pairs that meet the array length. These two antenna pairs are the first antenna pair (antenna x, antenna y) or the second antenna pair (antenna x, antenna y, antenna z), respectively. The number of antennas in the first antenna pair is two, and the codes for these two antennas are antenna x and antenna y, respectively. The number of antennas in the second antenna pair is three, and the codes for these three antennas are antenna x, antenna y, and antenna z, respectively.

To better understand antenna pairs that meet the array length, the embodiment of the present disclosure provides an example diagram as shown in FIG. 6. In FIG. 6, a terminal device can support four transmit eight receive (4Tx8Rx). The terminal can report that it supports an uplink beamforming capability on the frequency band A and can transmit antenna pairs that meet the array length requirements. For example, the antenna pairs that meet the array length can be the first antenna pair (antenna 1, antenna 3) and/or the second antenna pair (antenna 5, antenna 7).

The embodiments of the present application provide that the terminal device can report the antenna pairs that meet the array length, as well as the number and codes of the antennas in each antenna pair, to the terminal device, which allows for more accurate beamforming.

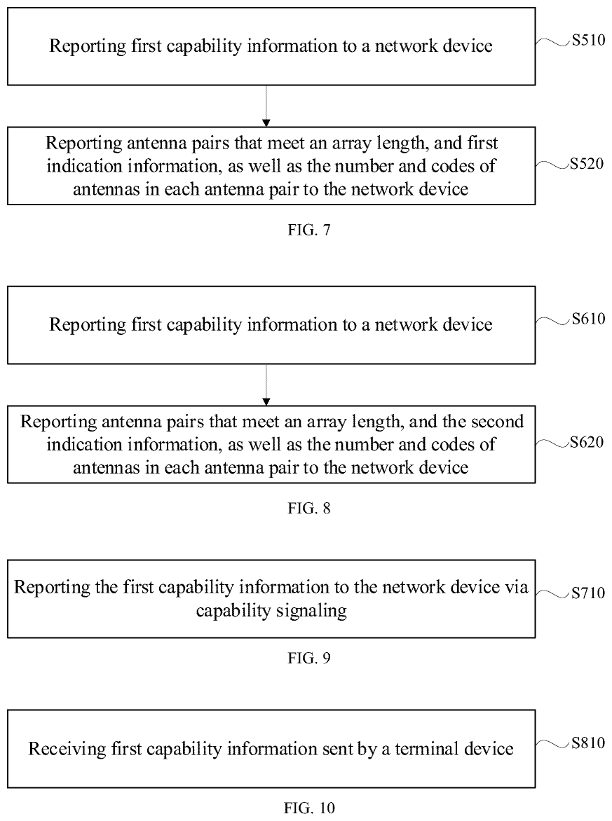

FIG. 7 illustrates a flowchart of a capability reporting method according to still other embodiments. As shown in FIG. 7, the capability reporting method can be used in a terminal device and includes the following steps.

In step S510, the first capability information is reported to the network device.

The specific implementation of step S510 has been described in detail in the previous embodiments and is not repeated here.

In step S520, antenna pairs that meet an array length, first indication information, as well as the number and codes of antennas in each antenna pair, are reported to the network device.

In some embodiments, the terminal device may report antenna pairs that meet an array length, first indication information, and the number and codes of antennas in each antenna pair to the network device. The first indication information may be used to indicate that the terminal device supports the scheduling of one antenna pair. Scheduling may be the process in which the network device selects an appropriate antenna pair based on the first capability information reported by the terminal device and performs signal transmission. In other words, the terminal device may send a plurality of antenna pairs and the first indication information to the network device. It may inform the network device that it supports scheduling of one antenna pair through the first indication information.

As an example, a terminal device may report that it supports the beamforming capability on the frequency band A, and may also report the antenna pairs that meet the array length. The antenna pairs that meet the array length may be the first antenna pair (antenna 1, antenna 3), the second antenna pair (antenna 5, antenna 7), or the third antenna pair (antenna 1, antenna 3, antenna 5, antenna 7). The number of antennas corresponding to the first antenna pair (antenna 1, antenna 3) is 2, and the corresponding antenna codes are antenna 1 and antenna 3. The number of antennas corresponding to the second antenna pair (antenna 5, antenna 7) is 2, and the corresponding antenna codes are antenna 5 and antenna 7, respectively. The number of antennas corresponding to the third antenna pair (antenna 1, antenna 3, antenna 5, antenna 7) is 4, and the corresponding antenna codes are antenna 1, antenna 3, antenna 5, and antenna 7, respectively.

In the embodiment of the present disclosure, the terminal device may send the antenna pairs that meet the array length, the first indication information, the number and codes of antennas in each antenna pair, along with the first capability information to the network device.

Optionally, the terminal device can also send the antenna pairs that meet an array length, the first indication information, and the number and codes of antennas in each antenna pair to the network device, after sending the first capability information. Optionally, the terminal device can first send the antenna pairs that meet an array length, the first indication information, and the number and codes of antennas in each antenna pair to the network device, and then report the first capability information to the network device. The specific timing for sending antenna pairs that meet an array length, the first indication information, as well as the number and codes of antennas in each antenna pair to the network device, is not specifically limited and can be determined based on actual circumstances.

For example, the terminal device may send the first indication information to the network device via RRC (Radio Resource Control) signaling, UCI (Uplink Control Information) signaling, or MAC CE (Medium Access Control-Control Element) signaling.

It should be noted that, for a plurality of embodiments or features separated by “or,” even if some features are not implementable, this does not affect other solutions. Furthermore, where no conflict exists, the embodiments of the present disclosure can be combined with other embodiments or implementations of capability reporting methods and their various optional solutions, which are not detailed here.

The embodiments of the present application provide that a terminal device may report antenna pairs that meet the array length and the first indication information, as well as the number and codes of antennas in each antenna pair, to a terminal device. The first indication information indicates that the terminal device supports scheduling of an antenna pair, thereby enabling more flexible beamforming.

FIG. 8 illustrates a flowchart of a capability reporting method according to yet still other embodiments. As shown in FIG. 8, the capability reporting method may be used in a terminal device and includes the following steps.

In step S610, the first capability information is reported to the network device.

The specific implementation of step S610 has been described in detail in the previous embodiments and is not repeated here.

In step S620, antenna pairs that meet an array length, and the second indication information, as well as the number and codes of antennas in each antenna pair, are reported to the network device.

In some implementations, the terminal device may report antenna pairs that meet an array length, the second indication information, as well as the number and codes of antennas in each antenna pair to the network device. The second indication information can be used to indicate that the terminal device simultaneously supports scheduling of a plurality of antenna pairs, as well as a combined code of the plurality of antenna pairs.

In other words, the terminal device can send a plurality of antenna pairs and the second indication information to the network device, and can inform the network device that it can simultaneously support scheduling of a plurality of antenna pairs, as well as the codes of the plurality of antenna pairs through the second indication information. For example, if the terminal device sends the first antenna pair (antenna x, antenna y) and the second antenna pair (antenna x1, antenna y1) to the network device, the terminal device may inform the network device that it can simultaneously support the scheduling of two antenna pairs through the second indication information. In this case, the combined code of the antenna pairs can be the first antenna pair and the second antenna pair.

As an example, a terminal device may report that it supports the beamforming capability on the frequency band A and may also report the antenna pairs that meet the array length. The antenna pairs that meet the array length may be the first antenna pair (antenna 1, antenna 3) and/or the second antenna pair (antenna 5, antenna 7) and/or the third antenna pair (antenna 2, antenna 4, or antenna 6, antenna 8), or the fourth antenna pair (antenna 1, antenna 3, antenna 5, antenna 7) and/or the fifth antenna pair (antenna 2, antenna 4, antenna 6, antenna 8).

In the embodiment of the present disclosure, the terminal device may send the antenna pairs that meet the array length, the second indication information, the number and codes of antennas in each antenna pair, along with the first capability information, to the network device.

Optionally, the terminal device can also send the antenna pairs that meet an array length, the second indication information, and the number and codes of antennas in each antenna pair to the network device, after sending the first capability information. Optionally, the terminal device can first send the antenna pairs that meet an array length, the second indication information, and the number and codes of antennas in each antenna pair to the network device, and then report the first capability information to the network device. The specific timing for sending antenna pairs that meet an array length, the second indication information, as well as the number and codes of antennas in each antenna pair to the network device, is not specifically limited and can be determined based on actual circumstances.

For example, the terminal device may send the second indication information to the network device via RRC signaling, UCI signaling, or MAC CE signaling.

It should be noted that, for a plurality of embodiments or features separated by “or,” even if some features are not implementable, this does not affect other solutions. Furthermore, where no conflict exists, the embodiments of the present disclosure can be combined with other embodiments or implementations of capability reporting methods and their various optional solutions, which are not detailed here.

The embodiments of the present application provide that a terminal device may report antenna pairs that meet the array length and second indication information, as well as the number and codes of antennas in each antenna pair, to a terminal device. The second indication information indicates that the terminal device simultaneously supports scheduling of a plurality of antenna pairs, and a combined code of the plurality of antenna pairs, thereby enabling more flexible and efficient beamforming.

FIG. 9 illustrates a flowchart of a capability reporting method according to still other embodiments. As shown in FIG. 9, the capability reporting method can be used in a terminal device and includes the following steps.

In step S710, first capability information is reported to a network device via capability signaling.

In the embodiments of the present disclosure, the terminal device can report the first capability information to the network device via capability signaling, where the capability signaling can be RRC signaling.

In a specific embodiment, the terminal device can report whether it supports the beamforming capability in the uplink transmission and/or downlink reception to the network device via RRC signaling, i.e., report the first capability information to the network device via RRC signaling.

It should be noted that, for a plurality of embodiments or features separated by “or,” even if some features are not implementable, this does not affect other solutions. Furthermore, where no conflict exists, the embodiments of the present disclosure can be combined with other embodiments or implementations of capability reporting methods and their various optional solutions, which are not detailed here.

The embodiments of the present application provide that a terminal device may report first capability information to a network device via capability signaling, which includes radio resource control (RRC) signaling. This allows for more flexible capability information reporting.

FIG. 10 is a flowchart illustrating a capability reporting method according to some embodiments. As shown in FIG. 10, the capability reporting method may be used in a network device and includes the following steps.

In step S810, the first capability information sent by a terminal device is received.

In the embodiments of the present disclosure, the first capability information may be used to indicate whether the terminal device in a first frequency range supports the beamforming capability.

In some embodiments, the network device may receive the first capability information sent by the terminal device per band, or the network device may receive the first capability information sent by the terminal device per band combination.

In other embodiments, the network device may receive antenna pairs that meet the array length, as well as the number and codes of antennas in each antenna pair sent by the terminal device.

In other embodiments, the network device may receive first indication information sent by the terminal device, and the first indication information may be used to indicate that the terminal device supports scheduling of one of the antenna pairs.

In other embodiments, the network device may receive second indication information sent by the terminal device. The second indication information may be used to indicate that the terminal device simultaneously supports scheduling of a plurality of antenna pairs and a combined code of the plurality of antenna pairs.

In other embodiments, the network device may receive the first capability information reported by the terminal device via capability signaling, which may include Radio Resource Control (RRC) signaling.

It should be noted that, for a plurality of embodiments or features separated by “or,” even if some features are not implementable, this does not affect other solutions. Furthermore, where no conflict exists, the embodiments of the present disclosure can be combined with other embodiments or implementations of capability reporting methods and their various optional solutions, which are not detailed here.

In embodiments of the present application, a network device may receive first capability information from a terminal device, and the first capability information may be used to indicate whether the terminal device in a first frequency range supports the beamforming capability. This enables the terminal device to utilize beamforming to improve cell coverage, i.e., transceiver capability of the terminal device may be enhanced through beamforming.

The present disclosure also provides a capability reporting system. The capability reporting system may include a terminal device and a network device. The terminal device may be used to perform operations related to the terminal device in the above embodiments, and the network device may be used to perform operations related to the network device in the above embodiments.

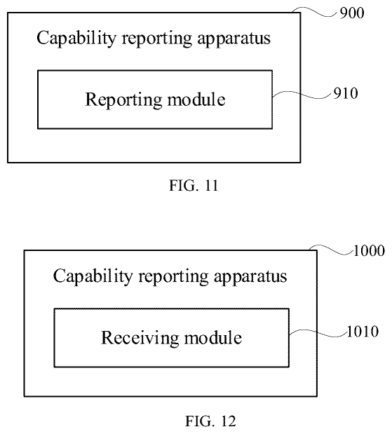

FIG. 11 is a block diagram of a capability reporting apparatus 900 according to some embodiments. Referring to FIG. 11, the capability reporting apparatus 900 is applied to a terminal device and may include a reporting module 910.

The reporting module 910 is configured to report first capability information to a network device, the first capability information indicates whether a terminal device in a first frequency range supports the beamforming capability.

In some embodiments, the first capability information indicates at least one of the following information: whether the terminal device supports the beamforming capability in an uplink transmission; and/or whether the terminal device supports the beamforming capability in a downlink reception.

In some embodiments, the reporting module 910 may be further configured to report the first capability information to the network device on a per-band or per-band-combination basis.

In some embodiments, the reporting module 910 may be further configured to report, to the network device, antenna pairs that meet an array length, and the number and codes of antennas in each antenna pair.

In some embodiments, the reporting module 910 may be further configured to report first indication information to the network device. The first indication information indicates that the terminal device supports the scheduling of one of the antenna pairs.

In some embodiments, the reporting module 910 may be further configured to report second indication information to the network device. The second indication information indicates that the terminal device simultaneously supports scheduling of a plurality of antenna pairs and a combined code of the plurality of antenna pairs.

In some embodiments, the reporting module 910 may be further configured to report the first capability information to the network device via capability signaling, which includes Radio Resource Control (RRC) signaling.

Embodiments of the present application provide that a terminal device may send first capability information to the network device, and the first capability information may be used to indicate whether the terminal device in a first frequency range supports the beamforming capability. This enables the terminal device to utilize beamforming to improve cell coverage. Thus, the transceiver capability of the terminal device is enhanced through beamforming.

FIG. 12 is a block diagram of a capability reporting apparatus 1000 according to some embodiments. Referring to FIG. 12, the capability reporting apparatus 1000 is applied to a network device and may include a receiving module 1010.

The receiving module 1010 is configured to receive first capability information sent by a terminal device, and the first capability information indicates whether the terminal device in a first frequency range supports the beamforming capability.

In some embodiments, the receiving module 1010 may be configured to receive the first capability information sent by the terminal device per band, or per band combination.

In some embodiments, the receiving module 1010 may be further configured to receive antenna pairs that meet an array length, and the number and codes of antennas in each antenna pair sent by the terminal device.

In some embodiments, the receiving module 1010 may be further configured to receive first indication information sent by the terminal device. The first indication information indicates that the terminal device supports the scheduling of one of the antenna pairs.

In some embodiments, the receiving module 1010 may be further configured to receive second indication information sent by the terminal device. The second indication information indicates that the terminal device simultaneously supports scheduling of a plurality of antenna pairs and a combined code of the plurality of antenna pairs.

In some embodiments, the receiving module 1010 may be further configured to receive the first capability information reported by the terminal device via capability signaling, and the capability signaling includes Radio Resource Control (RRC) signaling.

The embodiments of the present application provide that a network device may receive first capability information from a terminal device, and the first capability information may be used to indicate whether the terminal device in a first frequency range supports the beamforming capability. This enables the terminal device to utilize beamforming to improve cell coverage. Therefore, the transceiver capability of the terminal device is enhanced through the beamforming.

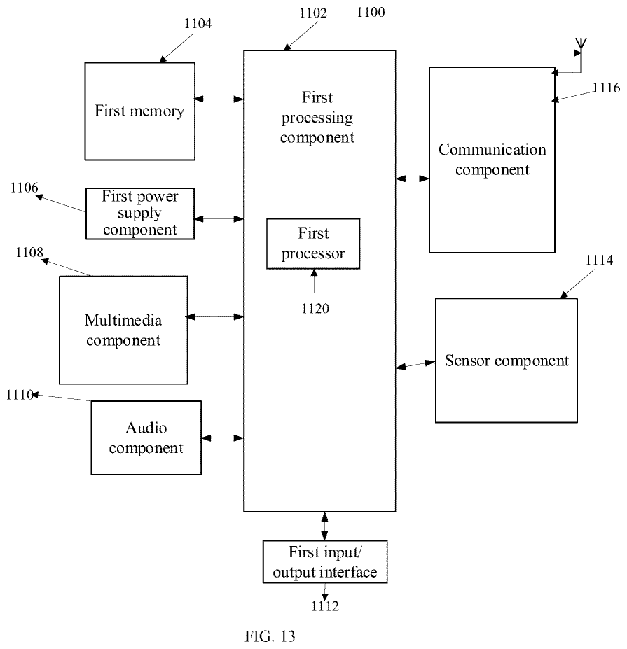

FIG. 13 is a block diagram of a terminal device according to some embodiments. For example, the terminal device 1100 may be a mobile phone, a computer, a digital broadcast terminal, a messaging device, a game console, a tablet device, a medical device, a fitness device, a personal digital assistant, or a smart car, etc.

Referring to FIG. 13, the terminal device 1100 may include at least one or more of the following components: a first processing component 1102, a first memory 1104, a first power supply component 1106, a multimedia component 1108, an audio component 1110, a first input/output (I/O) interface 1112, a sensor component 1114, and a communication component 1116.

The first processing component 1102 typically controls the overall operations of the terminal device 1100, such as the operations associated with display, telephone calls, data communications, camera operations, and recording operations. The first processing component 1102 can include one or more first processors 1120 to execute instructions to perform all or part of the steps in the above capability reporting methods. Moreover, the first processing component 1102 can include one or more modules to facilitate the interaction between the first processing component 1102 and other components. For example, the first processing component 1102 can include a multimedia module to facilitate the interaction between the multimedia component 1108 and the first processing component 1102.

The first memory 1104 is configured to store various types of data to support the operation of the terminal device 1100. Examples of such data include instructions for any application or method operated on the terminal device 1100, the contact data, the phone book data, messages, pictures, videos, and the like. The first memory 1104 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or an optical disk.

The first power supply component 1106 provides power to various components of the terminal device 1100. The first power supply component 1106 can include a power management system, one or more power sources, and other components associated with the generation, management, and distribution of power for the terminal device 1100.

The multimedia component 1108 includes a screen providing an output interface between the terminal device 1100 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also detect the duration time and pressure associated with the touch or swipe action. In some embodiments, the multimedia component 1108 includes a front camera and/or a rear camera. When the terminal device 1100 is in an operation mode, such as a photographing mode or a video mode, the front camera and/or the rear camera can receive external multimedia data. Each of the front camera and the rear camera may be a fixed optical lens system or have focus and optical zoom capability.

The audio component 1110 is configured to output and/or input an audio signal. For example, the audio component 1110 includes a microphone (MIC) configured to receive an external audio signal when the terminal device 1100 is in an operation mode, such as a call mode, a recording mode, and a voice recognition mode. The received audio signal may be further stored in the first memory 1104 or sent via the communication component 1116. In some embodiments, the audio component 1110 also includes a speaker for outputting the audio signal.

The first I/O interface 1112 provides an interface between the first processing component 1102 and peripheral interface modules, such as keyboards, click wheels, buttons, and the like. These buttons may include, but are not limited to, a home button, a volume button, a start button, and a lock button.

The sensor component 1114 includes one or more sensors for providing state assessments of various aspects of the terminal device 1100. For example, the sensor component 1114 can detect an open/closed state of the terminal device 1100, relative positioning of components, such as the display and the keypad of the terminal device 1100. The sensor component 1114 can also detect a change in position of one component of the terminal device 1100 or the terminal device 1100, the presence or absence of user contact with the terminal device 1100, an orientation, or an acceleration/deceleration of the terminal device 1100, and a change in temperature of the terminal device 1100. The sensor component 1114 can also include a proximity sensor configured to detect the presence of nearby objects without any physical contact. The sensor component 1114 can also include a light sensor, such as a CMOS or CCD image sensor, configured for use in imaging applications. In some embodiments, the sensor component 1114 can also include an accelerometer sensor, a gyroscope sensor, a magnetic sensor, a pressure sensor, or a temperature sensor.

The communication component 1116 is configured to facilitate wired or wireless communication between the terminal device 1100 and other devices. The terminal device 1100 can access a wireless network based on a communication standard, such as WiFi, 2G, 3G, or a combination thereof. In an example embodiment, the communication component 1116 receives broadcast signals or broadcast-associated information from an external broadcast management system via a broadcast channel. In an example embodiment, the communication component 1116 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology, and other technologies.

In an example embodiment, the terminal device 1100 may be implemented with one or more application specific integrated circuits (ASIC), digital signal processors (DSP), digital signal processing devices (DSPD), programmable logic devices (PLD), field programmable Gate arrays (FPGA), controllers, microcontrollers, microprocessors or other electronic components, to perform the above capability reporting methods.

In an example embodiment, a non-transitory computer-readable storage medium including instructions is also provided, such as a first memory 1104 including instructions. The instructions can be executed by the first processor 1120 of the terminal device 1100 to complete the above capability reporting methods. For example, the non-transitory computer-readable storage medium can be a ROM, a random-access memory (RAM), a CD-ROM, a magnetic tape, a floppy disk, or an optical data storage device.

In addition to being a standalone electronic device, the above apparatus may also be a part of another standalone electronic device. For example, in one embodiment, the apparatus may be an integrated circuit (IC) or a chip, the integrated circuit may be an IC or a collection of a plurality of ICs; the chip may include but not limited to the following types: Graphics Processing Unit (GPU), Central Processing Unit (CPU), Field Programmable Gate Array (FPGA), Digital Signal Processor (DSP), Application Specific Integrated Circuit (ASIC), System on Chip (SoC), etc. The above-mentioned integrated circuit or chip may be used to execute executable instructions (or codes) to implement the above capability reporting methods. The executable instructions may be stored in the integrated circuit or chip, or may be obtained from other apparatuses or devices, such as the integrated circuit or chip including a processor, a memory, and an interface for communicating with other apparatuses. The executable instruction may be stored in the memory, and when the executable instruction is executed by the processor, the above capability reporting methods are implemented; or, the integrated circuit or chip may receive the executable instruction through the interface and transmit it to the processor for execution, to implement the above capability reporting methods.

In another example embodiment, a computer program product is also provided, which includes a computer program executable by a programmable apparatus. The computer program includes a code portion for executing the above capability reporting methods when executed by the programmable apparatus.

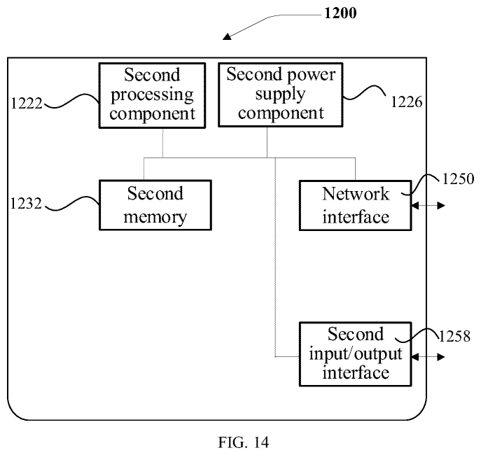

FIG. 14 is a block diagram of a network device according to an example embodiment. For example, the network device 1200 may be provided as a server. Referring to FIG. 14, the network device 1200 includes a second processing component 1222, which further includes one or more processors (not shown), and a memory resource represented by a second memory 1232 for storing instructions executable by the second processing component 1222, such as an application. The application stored in the second memory 1232 may include one or more modules, each corresponding to a set of instructions. In addition, the second processing component 1222 is configured to execute instructions to perform the above capability reporting methods.

The network device 1200 may also include a second power supply component 1226 configured to perform power management of the network device 1200, a wired or wireless network interface 1250 configured to connect the network device 1200 to a network, and a second input/output (I/O) interface 1258. The network device 1200 may operate based on an operating system stored in the memory 1232, such as Windows Server™, Mac OS X™, Unix™, Linux™, FreeBSD™, or the like.

Other embodiments of the present disclosure will readily occur to those skilled in the art after considering the specification and practicing the present disclosure. The present application is intended to cover any variation, use, or adaptation of the present disclosure, which follows the general principles of the present disclosure and includes common sense or common technical means in the technical field not disclosed in this disclosure. The description and embodiments are only regarded as exemplary, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the appended claims.

1. A capability reporting method, performed by a terminal device, comprising:
reporting first capability information to a network device, wherein the first capability information indicates whether the terminal device in a first frequency range supports a beamforming capability.

2. The method according to claim 1, wherein the first capability information indicates at least one of:
whether the terminal device supports the beamforming capability in an uplink transmission, or
whether the terminal device supports the beamforming capability in a downlink reception.

3. The method according to claim 1, wherein reporting the first capability information to the network device comprises:
reporting the first capability information to the network device per band, or per band combination.

4. The method according to claim 1, further comprising:
reporting, to the network device, antenna pairs that meet an array length, and a number of antennas and codes of the antennas in each of the antenna pairs.

5. The method according to claim 4, further comprising:
reporting first indication information to the network device, wherein the first indication information indicates that the terminal device supports scheduling of one of the antenna pairs.

6. The method according to claim 4, further comprising:
reporting second indication information to the network device, wherein the second indication information indicates that the terminal device simultaneously supports scheduling of a plurality of the antenna pairs and a combined code of the plurality of the antenna pairs.

7. The method according to claim 1, wherein reporting the first capability information to the network device comprises:
reporting the first capability information to the network device via capability signaling, and the capability signaling comprises Radio Resource Control (RRC) signaling.

8. A capability reporting method, performed by a network device, comprising:
receiving first capability information sent by a terminal device, wherein the first capability information indicates whether the terminal device in a first frequency range supports a beamforming capability.

9. The method according to claim 8, wherein receiving the first capability information sent by the terminal device comprises:
receiving the first capability information sent by the terminal device per band, or per band combination.

10. The method according to claim 8, further comprising:
receiving, from the terminal device, antenna pairs that meet an array length, and a number of antennas and codes of the antennas in each of the antenna pairs.

11. The method according to claim 10, further comprising:
receiving first indication information sent by the terminal device, wherein the first indication information indicates that the terminal device supports scheduling of one of the antenna pairs.

12. The method according to claim 10, further comprising:
receiving second indication information sent by the terminal device, wherein the second indication information indicates that the terminal device simultaneously supports scheduling of a plurality of the antenna pairs and a combined code of the plurality of the antenna pairs.

13. The method according to claim 8, further comprising:
receiving the first capability information reported by the terminal device via capability signaling, and the capability signaling comprises Radio Resource Control (RRC) signaling.

14-15. (canceled)

16. A user equipment, comprising:
a processor; and
a memory for storing instructions executable by the processor, and
wherein the processor is configured to execute the instructions:
report first capability information to a network device, wherein the first capability information indicates whether the user equipment in a first frequency range supports a beamforming capability.

17. A network device, comprising:
a processor; and
a memory for storing instructions executable by the processor, and
wherein the processor is configured to execute the instructions to implement the method according to claim 8.

18. A non-transitory computer-readable storage medium, having computer program instructions stored thereon, wherein the computer program instructions implement steps of the method according to claim 1 when executed by a processing device.

19. A non-transitory computer-readable storage medium, having computer program instructions stored thereon, wherein the computer program instructions implement steps of the method according to claim 8 when executed by a processing device.
